(19) United States
(12) Patent Application Publication
(10) Pub. No.: US 2019/0327158 A1
(43) Pub. Date: Oct. 24, 2019

(54) APPARATUS AND SYSTEM TO TEST CABLE

(71) Applicant: A.e. Media Solution (2016) Ltd, Raanana (IL)

(72) Inventors: Ariel MARCUS, Pardesiya (IL); Eliran Toren, Herzelia (IL)

(73) Assignee: A.e. Media Solution (2016) Ltd, Raanana (IL)

(21) Appl. No.: 16/459,631

(22) Filed: Jul. 2, 2019

Related U.S. Application Data
(63) Continuation of application No. 15/398,755, filed on Jan. 5, 2017, now abandoned.

(51) Int. Cl. H04L 12/26; H04L 12/10

(52) U.S. Cl. CPC H04L 43/0811; H04L 43/50; H04L 12/10

(57) ABSTRACT

A system for testing a HDBaseT installation is provided. The testing system includes a main unit to form a test procedure of the installed HDBaset medium, a transmitter to transmit test signals over an installed HDBaset medium and a receiver to receive the test signals and power adapter to test a power over Ethernet (PoE) or power over HDBaset PoH characteristic as defined by a HDBaseT standard.

### CROSS REFERENCE TO RELATED APPLICATIONS

This application is a continuation application of U.S. patent application Ser. No. 15/398,755, filed on Jan. 5, 2017, the entire contents of which is incorporated by reference.

### BACKGROUND OF THE INVENTION

HDBaseT is a connectivity standard which delivers uncompressed multimedia content, encapsulated using HDMI-HDCP link layer, from source to sink (unidirectional), control data between source and sink (bidirectional) and Ethernet data between the source and sink (bidirectional). It can also co-exist with power delivery over the same cable using Power over Ethernet (POE) and power over HDBaseT (PoH) methods. PoH can be used to transfer electrical power, along with data, to remote devices over a twisted-pair cable for example, HDBaseT transmitter and/or HDBaseT receiver.

HDBaseT operates over four twisted pairs, CAT5e/6 UTP cables, coaxial, two twisted pair and fiber. The cable length is up to 100 Meters. The HDBaseT link consists of two distinct, asymmetric, unidirectional sub links: the Downstream Sub Link and the Upstream Sub Link.

HDBaseT standard relates to several types of transport and/or delivered signals/power that may be transported over a HDBaseT compatible infrastructure. There is a need to enable testing of HDBaseT compatible infrastructure and more specifically testing the performance of a HDBaseT compatible cable after its installation and before it is approved and provided to a user. In some cases, specifically when the HDBaseT infrastructure is installed close to interference source, such as a high power transformer or engine, or an equipment operating high power switching devices that typically produce RF or EM interference, there is a need to test the HDBaseT infrastructure performance under environmental and operational conditions as close as possible to those that will influence the infrastructure after the plant is operating and running.

In certain situations, after the HDBaseT cabling has been installed, testing it to prove full compatibility to the standard, especially to prove compatibility in the presence of environmental interferences, when such interferences are not yet present, is hard or even impossible. In large scale plants where the cabling to be tested may run through several floors and cross several walls, the testing of the cabling, when end equipment is not yet connected and specifically when the entire plant is not yet powered, may impose a hard and labor consuming task.

### BRIEF DESCRIPTION OF THE DRAWINGS

The subject matter regarded as the invention is particularly pointed out and distinctly claimed in the concluding portion of the specification. For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The specification, however, both as to organization and method of operation, together with objects, features, and advantages thereof, may best be understood by reference to the following detailed description when read with the accompanying drawings in which:

FIG. 1 is a schematic block diagram illustration of a multimedia cable testing system, in accordance with some demonstrative embodiments;

FIG. 2 is a schematic illustration of a plurality of options of a cable installation test setup, in accordance with some demonstrative embodiments; and

FIG. 3 is a schematic illustration of a block diagram of a test setup to test an installation of HDBaseT system, in accordance with some demonstrative embodiments.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”. “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “exemplary embodiments”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The term “module” as used herein, may include hardware and/or software and/or any combination of software and hardware. For example, a memory module may be, but not limited to, a hardware unit configured to store data, instructions, information, measurement values etc. Protocol module may be, but not limited to, a combination of hardware and software configured to encapsulate and/or decapsulation communications, data and the like. Some protocol modules may include memory buffer, if desired.

Some embodiments may be used in conjunction with various networks and systems, for example, communication networks, Internet, telephone network, computer networks, sensors networks, cable network, wireless networks, cellular networks, local area networks (LAN), wireless LAN, wide area networks (WAM), wireless WAN and the like.

Demonstration embodiments may include a circuitry, for example an integrated circuit, a system on chip, a hybrid integrated circuit, an electronic circuit on a printed board and the like.

Logic, modules, devices and interfaces herein described may perform functions that may be implemented in hardware and/or code. Hardware and/or code may comprise software, firmware, microcode, processors, state machines, chipsets, or combinations thereof designed to accomplish the functionality.

According to some embodiments, an HDBaseT testing device may include for example HDBaseT transmitter unit, HDBaseT receiver unit and PoH adapter. The HDBaseT testing device may provide a testing platform for testing HDBaseT source and sink nodes, may be used to power devices, and may test performance compatibility up to 100 meters of CATx cabling for use in HDBaseT networks. For example, HDBaseT testing device may include a user input/output unit, such as a touch screen for operating and managing the HDBaseT testing device, and/or may be managed using a remotely executed application, for example an application executed on a mobile—e.g., a cellphone, a tablet, and/or a laptop computer, etc.

For example, a sink node may include a device with an High-Definition Multimedia Interface (HDMI) input and/or an HDBaseT input and/or audio/video interface for transferring uncompressed video data and compressed or uncompressed digital audio data such as, for example a television, a display or the like.

A source node may include a device with an HDMI output and/or an HDBaseT output and/or audio/video interface for receiving uncompressed video data and compressed or uncompressed digital audio such as, for example a lap top computer, tablet, digital video disc (DVD), a desktop computer or the like.

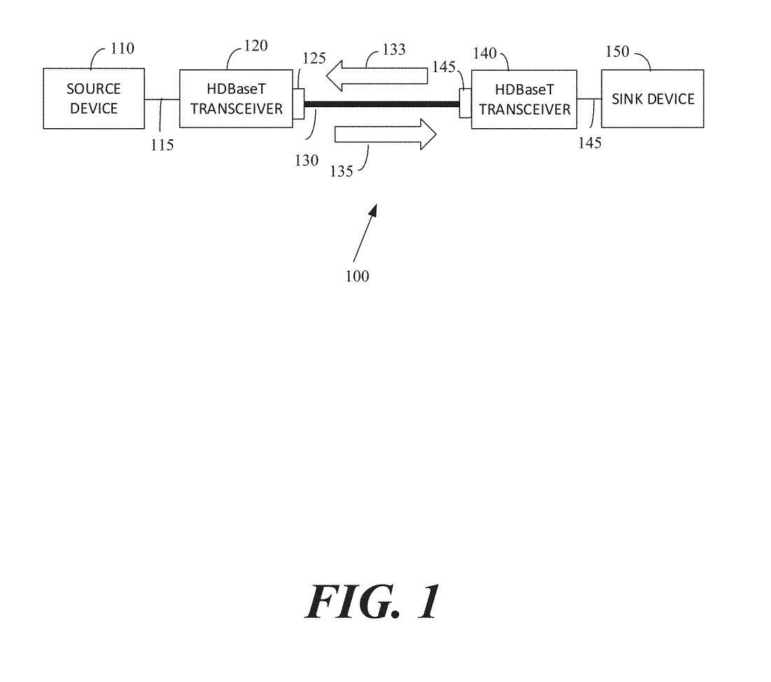

Reference is made to FIG. 1, which schematically illustrates a block diagram of a multimedia cable testing system 100, in accordance with some demonstrative embodiments. According to some embodiments, multimedia cable testing system 100 may include, for example, a source device 110, HDMI connection 115, HDBaseT transceiver 120 having a connector 125 adapted to connect to a HDBaseT compatible cable 130, connector 145, HDBaseT transceiver device 140 and HDMI connection 145 and a sink device 150.

In some embodiments, for example, cable 130 may include a twisted pair unshielded cable or shielded with RJ45 connector (e.g., connector 125 and connector 145) at each end of cable 130. Cable 130 may include for example, at least Cat5e, Cat6, and/or Cat LAN cables, coaxial, fiber cable two twisted pair cable and the like. RJ45 connector can be a plug and/or socket which may be used to terminate twisted pair cables

According to some embodiments, for example, a direction of a flow of multimedia signals from HDBaseT transceiver 120 device to HDBaseT transceiver device 140 (e.g., as indicated by arrow 135) may be referred as a downstream flow. For example, the communication and/or media signals direction of the downstream flow can be from the source node to the sink node.

A direction of a flow of multimedia signals from HDBaseT transceiver device 140 to HDBaseT transceiver 120 (e.g., as indicated by arrow 133) may be referred as a upstream flow. For example, the communication and/or media signals direction of the upstream flow can be from the sink node to the source node.

For example, source device 110 may include a DVD device and HDBaseT transceiver device 120 may include an HDBaseT transmitter. The HDBaseT transmitter may convert, for example, the DVD signals received from the DVD device to HDBaseT signals, if desired.

According to some embodiments, for example, sink device 150 may include a display and HDBaseT sink device 140 may include an HDBaseT receiver. The HDBaseT receiver may convert for example, HDBaseT signals received from a HDBaseT compatible cable to HDMI signals, if desired.

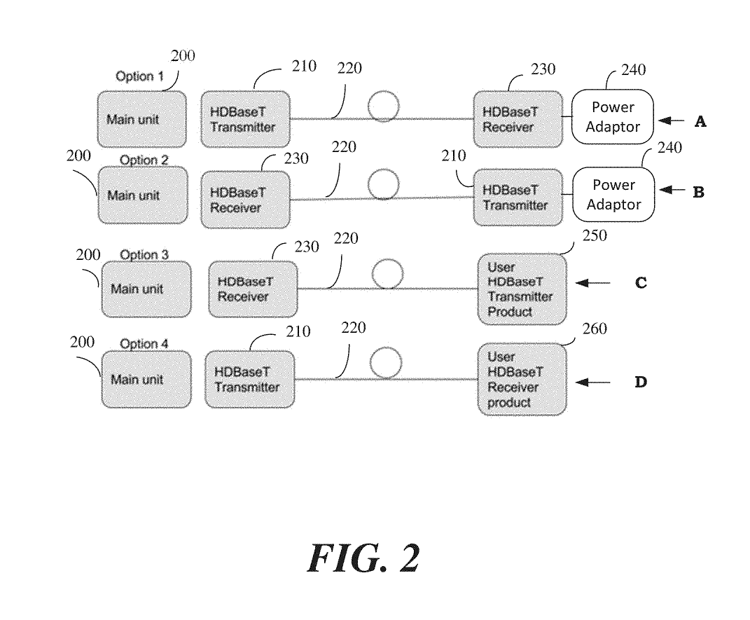

Reference is made to FIG. 2, which schematically illustrates plurality of options of an HDBaseT cable installation test setup, in accordance with some demonstrative embodiments. For example, a first option for HDBaseT cable installation test setup A may include main unit 200 operably coupled to HDBaseT transmitter 210, medium 220, HDBaseT receiver 230 and power adaptor 240. A second option B may include main unit 200 operably coupled to HDBaseT receiver 230, medium 220, HDBaseT transmitter 210 and power adaptor 240. A third option C may include main unit 200 operably coupled to HDBaseT receiver 230, medium 220 and a source device 250 (e.g., DVD). A fourth option D may include main unit 200 operably coupled HDBaseT transmitter 210, medium 220 and sink device 260 (e.g. a display). With some embodiments of the invention, for example, both source device 250 and sink device 260 may include HDBaseT interface (not shown) and may be compatible with HDBaseT standard.

According to some embodiments, for example medium 220 may can be the physical cable layer of HDBaseT standard and may include a multiple twisted pair cable also known as cat cable at a desired grade, a coaxial cable, a twisted pair cable, a fiber optic, etc.

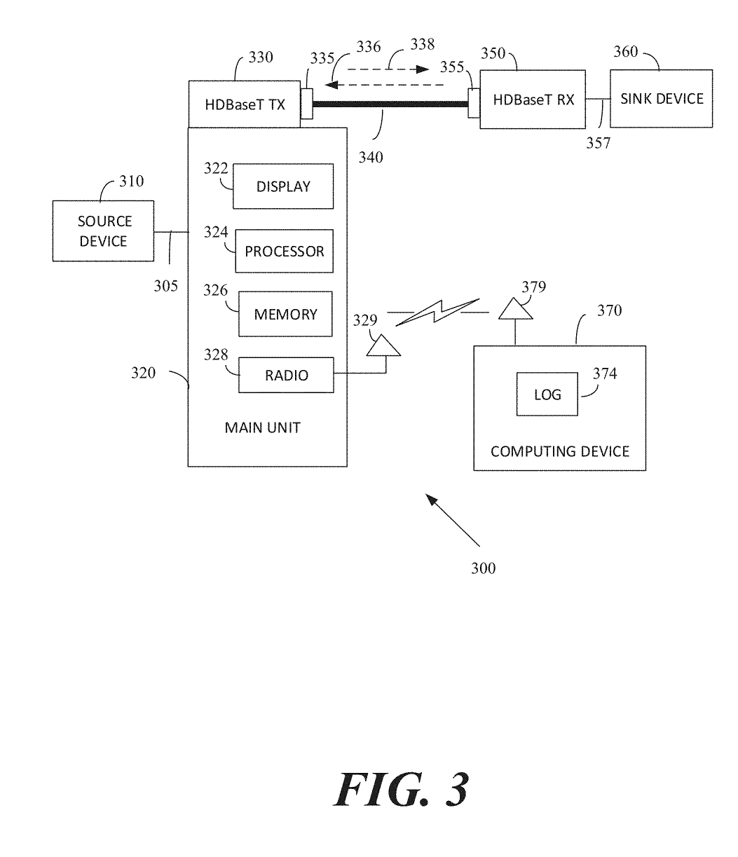

Reference is made to FIG. 3, which schematically illustrates a block diagram of a test setup to test an installation of HDBaseT infrastructure 300, in accordance with one example embodiment. For example. HDBaseT infrastructure 300 may include optionally source device 310, an HDBaseT tester main unit 320, a HDBaseT tester transmitter unit 330, HDBaseT connecting means 335 such as, for example, a RJ-45 connector, a HDBaseT tested cable 340 such as, for example a twisted pair cable, a CAT family cable (e.g., CATx cable), a coaxial, a fiber and/or any other HDBaseT standard supported cable, HDBaseT TRANSCEIVER a HDBaseT connecting means 355 such as, for example, a RJ-45 connector, a HDBaseT tester receiver unit 350, an optionally HDBaseT sink device 360, e.g., a display and a computing device 370.

According to some demonstrative embodiments, for example, source device 310 may include a DVD, a laptop computer, a desktop computer, a control device, a memory stick, a USB device, a network camera and the like. Source device 310 may be coupled to HDBaseT tester main unit 320 for example, by a HDMI interface 305, although it should be understood that source device 310 may be coupled to HDBaseT tester main unit 320 by other interface.

According to some embodiments, HDBaseT tested cable tested cable 340 may be connected to HDBaseT tester transmitter unit 330, for example, by RJ-45 connector 335 at one end and to HDBaseT tester receiver unit 350 through, for example, RJ-45 connector 355 at the second end. HDBaseT tester receiver unit 350 may be optionally connected for example to sink device 360 by a HDMI interface 357, if desired.

According to some embodiments, for example, HDBaseT tester main unit 320 may include a user I/O interface 322, such as, for example, a touch screen display, a processor 324, a memory 326, a wireless communication unit 328 adapted to communicate with remote units, such as for example a local area (WLAN) radio connected to one or more antennas 329.

For example, processor 324 may send a test signal over a downstream 338 and may receive traffic from installed cable 340 over an upstream 336. The test signal may include some or all of the types of traffic according to HDBaseT standard, either concurrently or otherwise. For example, the test signal may comprise of types of possible traffic. The test signal may be provided in its maximum allowable capacity, for example in order to test the HDBaseT cable under maximum traffic load conditions, in order to ensure compatibility of tested cable 340 with the HDBaseT standard. Processor 324 may monitor the traffic of installed cable 340, may analyze the test data and may display the test data on user I/O interface unit 322. Main unit 320 may also analyze the test data and provide to the user indication of the extent at which the installed cable 340 complies with the standard.

According to some embodiments, for example, HDBaseT tester main unit 320 may send the test data and/or the analysis of same via wireless communication unit 328, e.g., WLAN radio and the one or more antennas 329 to computing device 370. Computing device may receive the test data via antenna 379 and may save the test data at a test log 374.

According to some embodiments, in order to monitor the actual performance of the tested cable 340 in operational conditions, such as, for example, when the environment near tested cable 340 may be in operation and may induce interference such as, for example, Electromagnetic Interference (EMI) and/or Radio Frequency Interference (RFI) interference, the test setup, e.g., HDBaseT tester main unit 320, HDBaseT tester transmitter unit 330, HDBaseT tester receiver unit 350, may be left connected to tested cable during a long enough period of time and the test log may be accumulated by computing device 370 and later on be analyzed along with time-related data reflecting the operation of EMI/RFI potential devices, in order to identify a match between detected degradation in the performance of tested cable 340 and recorded operation of EMI/RFI sources.

According to some embodiments, for example. HDBaseT tester main unit 320 may test in a real time an installed cable performance such as, for example installed cable, e.g., HDBaseT cable may include four twisted pairs of wires. A twisted pair wire may be referred as a channel, thus in this specific example HDBaseT tester main unit 320 may test the performance of four HDBaseT channels, e.g., channels A, B, C and D, simultaneously, if desired. According to this example, HDBaseT tester main unit 320 may test a maximum recorded value of the residual error (MaxErr). The Max Error measurement may be an absolute value of the maximal distance between an input signal on a given channel and a predetermined threshold in a HDBaseT modulation detection scheme.

For example, the Max Error measurement may behave as a peak detector and the value read may be the maximal error witnessed on the tested channel. Furthermore, in order to calculate the MaxErr from the 8 bits read per channel (n), the following equation may be used: MaxErr=n/27.

According to some embodiments, for example, HDBaseT tester main unit 320 may measure a mean square error (MSE) in db for each channel. For example, 4 bytes (32 bits) may allocated per channel as follows: Channel A: Least Significant 4-byte Word; channel B: 4-byte word; channel C: 4-byte word; and channel D: Most Significant 4-byte Word. An actual MSE value may be a fractional negative number of db. The higher the absolute value of the MSE, the better the quality of the HDBaseT reception (e.g., −19.8 db is better than −18.3 db). In order to calculate the MSE from the 32 bits (n) read per channel, the following equation may be used:

MSE=(20*log 10(n219))+2

According to some embodiments, for example, HDBaseT tester main unit 320 may read parameters of installation of HDBaseT infrastructure 300. HDBaseT tester main unit 320 may receive and display the following information for the configuration of the transmitter and/or receiver configuration: a chip's firmware version, a clock frequency of the video transmission, a class of HDBaseT chip according to the HDBaseT Standard, a chip model/part number, supported features such as HDML Ethernet, RS232 or the like, infrared support provided by the chip, vendor and device ID, USB support provided by the chip according to the HDBaseT standard, link status, (e.g., HDBaseT or No link), system mode (for example, if operating mode changes may performed automatically or manually), cable length in meters, a current HDBaseT operating mode (for example. HDBaseT, LPPF1/2, Disconnect, FB (Ethernet Fallback), Bypass Mode or Long Reach (LR)) and a video status.

According to some embodiments, for example the positions of HDBaseT tester transmitter unit 330 and a HDBaseT tester receiver unit 350 may be interchangeable, if desired While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for testing data and media performance over an installed medium, the system comprising:
a first unit (320) to form a test procedure of the installed medium and to cause a second unit to transmit one or more signals according to the test procedure;
a second unit (330) operably coupled to the first unit at one end and to a first edge of the installed cable, the second unit is configured to communicate at least one of a media signal, a digital data signal, a control signal, an Internet traffic signal and a power over Ethernet (PoE) over the medium cable; and
a third unit (350) operably coupled to a second edge of the installed cable, the third unit is configured to communicate at least one of a media signal, a digital data signal, a control signal, Internet traffic signal and a power over Ethernet (PoE) over the installed medium.

2. The system of claim 1, comprising:
a power supply adapter unit coupled to the second unit, wherein the power adapter is configured to deliver the power to the second unit using a PoE method.

3. The system of claim 1, comprising:
a power supply adapter unit coupled to the third unit, wherein the power adapter is configured to deliver the power to the third unit over the installed cable using a power over HDBaseT (PoH) method.

4. The system of claim 1, wherein the second unit comprises an HDBaseT transmitter.

5. The system of claim 1, wherein the second unit comprises an HDBaseT receiver.

6. The system of claim 1, wherein the third unit comprises an HDBaseT transmitter.

7. The system of claim 1, wherein the third unit comprises an HDBaseT receiver.

8. The system of claim 1, wherein the second unit comprises an HDBaseT transmitter operably coupled to the installed medium at one end and a user HDBaseT receiver product is coupled to the installed medium at the other end.

9. The system of claim 1, wherein the second unit comprises an HDBaseT receiver operably coupled to the installed medium at one end and a user HDBaseT transmitter product is coupled to the installed medium at the other end.

10. The system of claim 1, wherein the first unit is configured to test the installed medium for compatibility to HDBaseT standard.

11. The system of claim 1, wherein the test procedure is adapted to test the HDBaseT standard performance of a HDBaseT medium based on the HDBaseT standard.

12. An apparatus to test an installed cable, the apparatus comprising:
a user interface unit to control a test setup and to display test results of the installed medium;
a processor to send a test signal over a downstream, receive traffic from the installed medium over an upstream, monitor the traffic of the installed medium and analyze the traffic;
a wireless communication unit to communicate with a computing device to present a test log at the computing device,
wherein
the apparatus is coupled to the installed cable via a first unit which is coupled to a first end of the installed medium; and
a second unit which is coupled to a second end of the installed medium,
the installed medium comprises a plurality of twisted pair wires to transfer audio, video, data, control signals, Internet and power between the first unit and the second unit.

13. The apparatus of claim 12, wherein the first unit comprises an HDBaseT transmitter.

14. The apparatus of claim 12, wherein the first unit comprises an HDBaseT receiver.

15. The apparatus of claim 12, wherein the second unit comprises an HDBaseT transmitter and coupled to a power adapter.

16. The apparatus of claim 12, wherein the second unit comprises an HDBaseT receiver.

17. The apparatus of claim 12, wherein the first unit comprises an HDBaseT transmitter and the second unit comprises a user HDBaseT transmitter product.

18. The system of claim 12, wherein the first unit comprises an HDBaseT receiver and the second unit comprises a user HDBaseT receiver product.

19. The apparatus of claim 12, is configured to test the installed medium for compatibility to HDBaseT standard.

20. The apparatus of claim 12, wherein the installed medium comprises at least one of a CAT family cable, a two twisted pair cable and a fiber optic cable, a length of any of the CAT family cable, the two twisted pair cable and the fiber optic cable is up to 100 meters.
